(19) United States
(12) Patent Application Publication
(10) Pub. No.: US 2023/0401623 A1
(43) Pub. Date: Dec. 14, 2023

(54) EXHIBITING METHOD OF NFT PRODUCT

(71) Applicant: Chih-Pin TANG, New Taipei City (TW)

(72) Inventor: Chih-Pin TANG, New Taipei City (TW)

(21) Appl. No.: 18/331,444

(22) Filed: Jun. 8, 2023

Related U.S. Application Data
(60) Provisional application No. 63/350,431, filed on Jun. 9, 2022.

(30) Foreign Application Priority Data
May 31, 2023 (TW) 112120416

(51) Int. Cl. G06Q 30/0601

(52) U.S. Cl. CPC G06Q 30/0625; G06Q 30/0643; G06Q 2220/165

(57) ABSTRACT

An exhibiting method of NFT product includes: sorting multiple NFT products according to the price of each NFT product to generate a first NFT product price sequence table; analyzing the first NFT product price sequence table according to the rarity ranking to generate a second NFT product price sequence table; making the rarity rankings of the next NFT products are all prior to the rarity rankings of the previous NFT products to generate a third NFT product price sequence table according to the second NFT product price sequence table and rarity rankings; defining multiple sections on the website according to the number of NFT products in the third NFT product price sequence table, each section includes multiple blocks; and displaying the NFT products located in the third NFT product price table sequentially in the first block of each section.

### CROSS-REFERENCES TO RELATED APPLICATIONS

This application claims the benefit of U.S. provisional application Ser. No. 63/350,431, filed on Jun. 9, 2022 and claims the priority of Patent Application No. 112120416 filed in Taiwan, R.O.C. on May 31, 2023. The entirety of the above-mentioned patent applications are hereby incorporated by references herein and made a part of the specification.

### BACKGROUND

### Technical Field

The present invention relates to an exhibiting method of NFT product.

### Related Art

Currently, there is no difference in the rarity of each stock of the same company traded on the open market for stock quotations, so the pricing and reference price are the current lowest prices, and the stock trading system is relatively simple, but NFT products have the dual characteristics of “uniqueness” and “rarity” that traditional trading products do not have. Take common “pattern” NFT products as an example, a comic company can issue 10,000 NFT character patterns. Each character pattern is different and unique, but some character patterns may have the same properties. For example, among the 10,000 character patterns, there are 5,000 character patterns with “blue hair” and 4,900 character patterns with “red hair”, but only 100 character patterns with “purple hair”. Then, without considering other properties, even if each character pattern is unique, the rarity evaluation of these 100 character patterns with “purple hair” will be higher than other character patterns.

It is further assumed that among the 10,000 character patterns, 5,550 of them have “white clothes” and 4,350 of them have “purple clothes”, but only 100 of them have “blue clothes”. Likewise, even if each character pattern is unique, the rarity evaluation of these 100 character patterns with “blue clothes” will be higher than other character patterns, without considering other properties.

In the above example, both “purple hair” and “blue clothes” belong to the properties with a small number. Considering the hair color and clothing color comprehensively, it is assumed that the properties of the character pattern are shown in the following table:

| Property | Number |
|---|---|
| blue hair + white clothes | 3000 |
| blue hair + purple clothes | 1950 |
| blue hair + blue clothes | 50 |
| red hair + white clothes | 2500 |
| red hair + purple clothes | 2360 |
| red hair + blue clothes | 40 |
| purple hair + white clothes | 50 |
| purple hair + purple clothes | 40 |
| purple hair + blue clothes | 10 |

Through the above example, we can understand why each NFT product is unique, but there are still differences in rarity between them. It can be seen from the above table that as long as the character pattern contains more kinds of properties “with a small number”, the rarer it will be. Based on the law of supply and demand in economics, compared to other character patterns, the “rarer” character patterns should theoretically have a higher price in the market, which is the market clearing price in economics. In some cases, rarity may only depend on the supply on the supply side, but in some cases, for the rarity, the demand on the demand side must also be considered. For example, in the 10,000 character patterns, the number of property A is twice the number of property B, but the market consumption model determines that the market preference degree (potential demand degree) of property A is ten times the market preference degree of characteristic B. Then, a character pattern with property A will be considered rarer than a character pattern with property B.

When a buyer tries to choose a suitable target to buy from the 10,000 character patterns, in addition to subjective factors (such as whether the painting style is liked by the buyer), the first thing the buyer needs to consider objectively is whether the price is reasonable, and the second thing is whether there is room for value-added in the future, and these two factors are related to rarity. However, there is currently no way for buyers to know whether an NFT product is suitable for buying at the moment of the transaction. It should be noted that whether the so-called price is reasonable means “the so-called price is relatively reasonable” rather than “the so-called price is absolutely reasonable”. After all, when a buyer really likes a character pattern and must have it, the law of supply and demand in economics does not apply. Take the above-mentioned 10,000 character patterns as an example, the suitable target to buy referred to in the present invention refers to the rarest character pattern that can be bought at a specific price at the current point in time. For example, if the specific price is 10 dollars, then the rarest character pattern that can be bought at 10 dollars is the so-called suitable target to buy.

Existing NFT trading platforms, such as the most well-known “Opensea”, only have a simple trading interface that simply displays NFT products on the website. It only provides users with the ability to sort these NFT products according to the price at most. Some program developers have developed tools that can evaluate rarity now. Take the aforementioned character patterns as an example again, as long as the user installs the tool, these character patterns can be sorted according to the rarity of each NFT product, and the rarity ranking of the character pattern can even be seen at a specific position of each character pattern.

However, since the pricing of NFT products is very chaotic and there are no guidelines to follow for setting the pricing of NFT products, the pricing of NFT products depends entirely on the pricing set by their owners. Therefore, it is often found that even for NFT products that are very non-rare, the asking price of their owners is much higher than the price of the NFT products that are rarer than them. Therefore, for buyers who want to trade NFT products, whether they sort NFT products by their price and by their rarity or take several hours to browse through all 10,000 character patterns, it is still impossible to easily determine which the character pattern is suitable for buying from the vast 10,000 character patterns. This not only makes NFT transactions have many risks, but also deters those who are interested in participating in NFT transactions.

### SUMMARY

In one embodiment, an exhibiting method of NFT product is provided, which applies to displaying multiple NFT products on a NFT trading website, each NFT product has a price and a rarity ranking, the exhibiting method of NFT product comprising: a. sorting the NFT products to generate a first NFT product price sequence table according to the prices of the NFT products; b. analyzing the first NFT product price sequence table and sorting the NFT products with the same price according to the order of rarity ranking, and moving out the NFT products whose rarity ranking is not the first in the same price to generate a second NFT product price sequence table; c. comparing the rarity rankings of the two adjacent NFT products according to the second NFT product price sequence table, assuming that the two adjacent NFT products are respectively defined as a previous NFT product and a later NFT product, if the rarity ranking of the later NFT product is lower than the rarity ranking of the previous NFT product, then moving out the later NFT product, the NFT product originally located after the later NFT product will be replenished forward and become adjacent to the previous NFT product; d. repeating step c until the rarity ranking of the later NFT product is higher than the rarity ranking of the previous NFT product in any two adjacent NFT products, so as to generate the third NFT product price sequence table; e. defining multiple sections in a website according to the number of NFT products in the third NFT product price sequence table, each section includes multiple blocks; and f. sequentially displaying the NFT products in the third NFT product price sequence table in the first block of each section.

In one embodiment, an exhibiting method of NFT product is provided, which applies to displaying multiple NFT products on a NFT trading website, each NFT product has a price and a rarity ranking, the exhibiting method of NFT product comprising: a. sorting the NFT products to generate a first NFT product price sequence table according to the prices of the NFT products; b. analyzing the first NFT product price sequence table and sorting the NFT products with the same price according to the order of rarity ranking to generate a second NFT product price sequence table; c. defining the first NFT product in the second NFT product price sequence table as a leading object of a first price zone, and then comparing the NFT products with the leading object of the first price zone, a comparing criterion is to sequentially find the first NFT product whose price is higher than the price of leading object in the first price zone and whose rarity ranking is higher than the leading object of the first price zone, and defining the NFT product which meets the comparing criterion as a leading object of a second price zone, and defining the NFT product prior to the leading object of the second price zone as a last object of the first price zone, the NFT products in the first price zone includes the leading object of the first price zone, the last object of the first price zone and all NFT products sorted between the leading object of the first price zone and the last object of the first price zone, and the leading object of the second price zone replaces the leading object of the first price zone and becomes a comparing target of the comparing criterion of a new price zone; d. repeating step c, sequentially finding out the leading object and the last object of each price zone according to the second NFT product price sequence table and the comparing criterion; e. defining multiple sections in a website according to the number of price zones in the third NFT product price sequence table, each section includes multiple blocks; and f. sequentially displaying the leading object of each price zone in the second NFT product price sequence table in the first block of each section.

In one embodiment, an exhibiting method of NFT product is provided, which applies to displaying multiple NFT products on a NFT trading website, each NFT product has a price and a rarity ranking, the exhibiting method of NFT product comprising: a. sorting the NFT products to generate a first NFT product price sequence table according to the prices of the NFT products; b. analyzing the first NFT product price sequence table and sorting the NFT products with the same price according to the order of rarity ranking to generate a second NFT product price sequence table; c. Classifying the NFT products in the second NFT product price sequence table into multiple price zones according to the price of the NFT products and comparing the rarity rankings of the NFT products in two adjacent price zones, assuming that the two adjacent price zones are respectively defined as a previous price zone and a later price zone, if the rarity ranking of the leading object in the later price zone is lower than the rarity ranking of the leading object in the previous price zone, all NFT products in the later price zone will be moved out, the price zone originally located after the later price zone will be replenished forward and become adjacent to the previous price zone. d. repeating step c until in any two adjacent price zones, the rarity ranking of the leading object in the later price zone is higher than the rarity ranking of the leading object in the previous price zone to generate a third NFT product price sequence table. e. defining multiple sections in a website according to the number of price zones in the third NFT product price sequence table, and each section includes multiple blocks; and f. sequentially displaying the leading object of each price zone in the third NFT product price sequence table in the first block of each section.

The following will describe the detailed features and advantages of the instant disclosure in detail in the detailed description. The content of the description is sufficient for any person skilled in the art to comprehend the technical context of the instant disclosure and to implement it accordingly. According to the content, claims and drawings disclosed in the instant specification, any person skilled in the art can readily understand the goals and advantages of the instant disclosure.

### BRIEF DESCRIPTION OF THE DRAWINGS

FIG. 1 is a schematic diagram of one embodiment of a NFT product.

FIG. 2 is a schematic diagram of one embodiment of properties of a NFT product.

FIG. 3 is a schematic diagram of one embodiment of NFT products with a rarity ranking.

FIG. 4 is a flow chart of one embodiment of an exhibiting method of NFT product.

FIG. 5A and FIG. 5B are schematic diagrams of one embodiment of an exhibiting method of NFT product.

FIG. 6 is a flow chart of another embodiment of an exhibiting method of NFT product.

FIG. 7 is a schematic diagrams of another embodiment of an exhibiting method of NFT product.

FIG. 8 is a flow chart of the other embodiment of an exhibiting method of NFT product.

FIG. 9A and FIG. 9B are schematic diagrams of the other embodiment of an exhibiting method of NFT product.

### DETAILED DESCRIPTION

The following will take 10,000 NFT products of character pattern as an example to illustrate how the present invention rearranges the 10,000 character patterns so that users can intuitively see which of the 10,000 character patterns are suitable targets to buy.

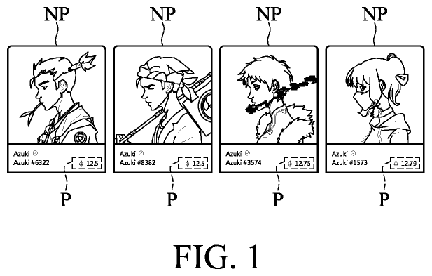

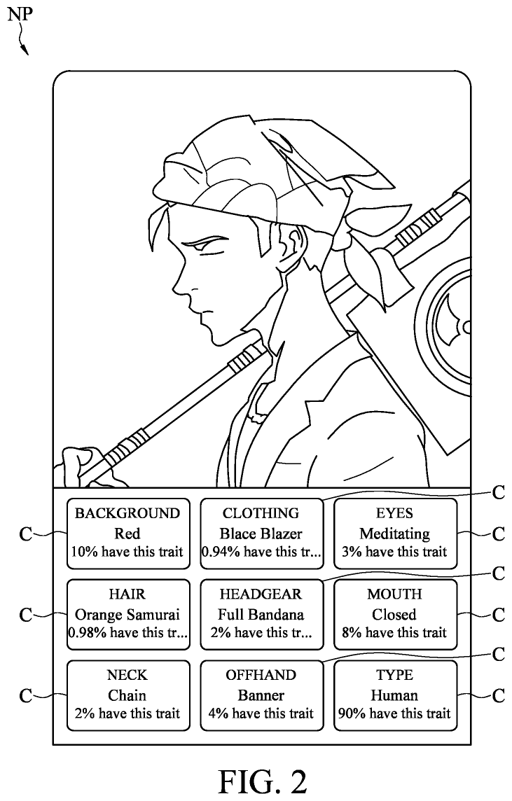

FIG. 1 is a schematic diagram of one embodiment of a NFT product NP. Please refer to FIG. 1. Every NFT product NP has a price P. The unit of the price P is Ether (Ether is a cryptocurrency unit, currently valued at approximately $22,625) In some embodiments, NFT products have been edited by the publisher to include multiple properties C. FIG. 2 is a schematic diagram of one embodiment of properties C of a NFT product. Please refer to FIG. 2. In some embodiments, property C may be but not limited to Background, Clothing, Eyes, Hair, Headgear, Mouth, Neck, Offhand or Type. In some embodiments, Every NFT product NP further has a rarity ranking RK. The rarity ranking RK is obtained by analyzing the properties C of the 10,000 NFT products NP of character pattern through the tool for determining the rarity ranking RK. Different tools can have different rarity ranking RK determining algorithms, but the rarity ranking RK determining standard is not within the scope of the present invention. As long as the tool can analyze the rarity ranking RK of each NFT product NP based on the same criterion and can be used for the rarity ranking RK sorting of the 10,000 NFT products NP, it can be used in the present invention. The technical content of the present invention only involves utilizing the rarity ranking RK information of the 10,000 NFT products NP analyzed by the tool, and does not propose a new rarity ranking RK determining method. In some embodiments, The tool for determining the rarity ranking RK may be but not limited to rarity.tools.

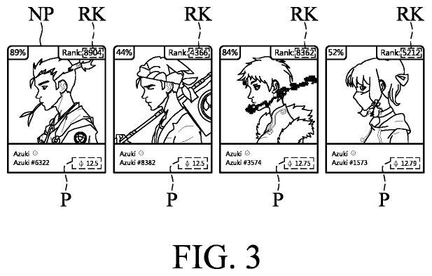

FIG. 3 is a schematic diagram of one embodiment of NFT products NP with a rarity ranking RK. Please refer to FIG. 3. In some embodiments, when the tool for determining the rarity ranking RK executes the rarity ranking RK determining algorithm to analyze the properties C of the 10,000 NFT products of character pattern to obtain the rarity ranking RK of the NFT product NP, the tool will display the rarity ranking RK on the character pattern of each NFT product NP. In some embodiments, the rarity ranking RK will be displayed in the upper right corner of the character pattern of the NFT product NP with the text “RK:” and a number. The number after the text “RK:” represents the rarity ranking RK of the NFT product NP among the 10,000 NFT products NP, for example, 8904 is equivalent to ranking 8904. In some embodiments, the tool further displays the rarity ranking RK of the NFT product NP among the 10,000 NFT products NP in the upper left corner of the character pattern of the NFT product NP in the form of a percentage value rounded to single digits. For example, if the rarity ranking RK of the NFT product NP is 8904th, the tool will display the rarity ranking RK on the NFT product NP in the form of a percentage value rounded to single digits (i.e. 89%) in the upper left corner of the character pattern.

As can be seen from FIG. 3, between NFT products NP priced at 12.5 Ether, the difference in rarity ranking RK can be as high as 4538 at most. If the buyer wants to spend 12.5 Ether to buy NFT product NP, he/she must spend a lot of time reading all the information of the NFT products NP whose price P is 12.5 Ether to determine which NFT product NP can be purchased at the top of the rarity ranking RK by spending 12.5 Ether, so as to prevent him/her from buying an NFT product NP whose rarity ranking RK is lower than other NFT products NP with the same price P. In addition, if the buyer thinks that the rarity ranking RK of the NFT product NP that can be purchased for 12.5 Ether is too low after reading all the information of the NFT product NP whose price P is 12.5 Ether, and wants to increase the budget to a higher price, such as 20 Ether. At this time, the buyer must read all the information of all NFT products NP whose price P is 20 Ether, in order to know which NFT product NP can be purchased at the top of the rarity ranking RK by spending 20 Ether. Therefore, the existing trading platforms are quite unfriendly to buyers and unable to simultaneously satisfy the ranking of price P and rarity ranking RK among the information of a large number of NFT products NP, which in turn affects the activity of the NFT trading market.

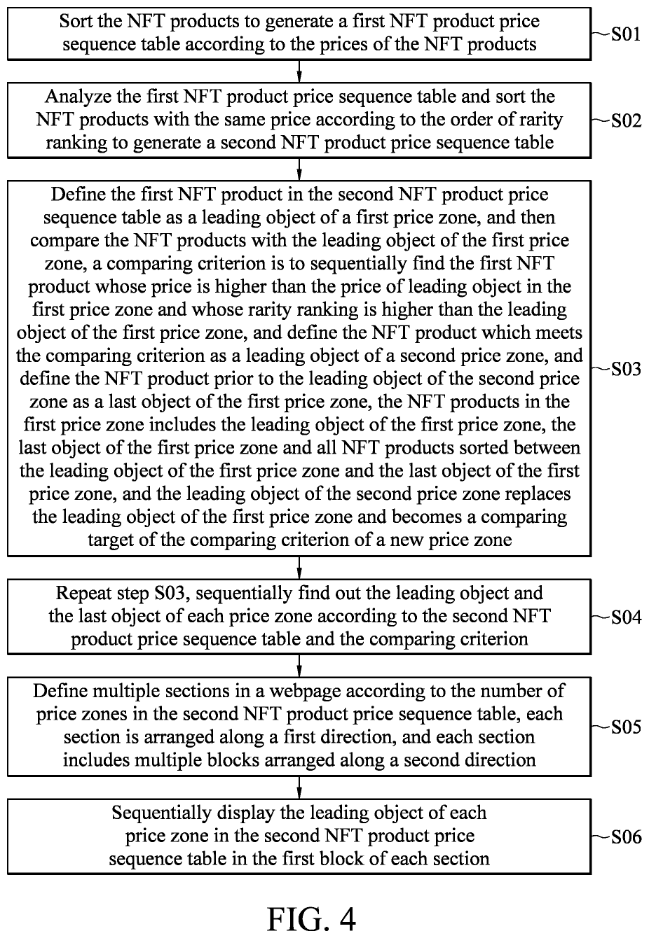

FIG. 4 is a flow chart of one embodiment of an exhibiting method of NFT product NP. Please refer to FIG. 1 to FIG. 4. The exhibiting method of NFT product applied to displaying multiple NFT products on a NFT trading website. First, sort the NFT products NP to generate a first NFT product price sequence table according to the prices P of the NFT products NP (Step S01). An example of the first NFT product price sequence table is shown in Table 1 below.

TABLE 1

| NFT Product NP | Price P(ETH) | Rarity Ranking RK |
|---|---|---|
| Product 1 | 10 | 9500 |
| Product 2 | 10 | 7500 |
| Product 3 | 10 | 8500 |
| Product 4 | 11 | 6500 |
| Product 5 | 12 | 6000 |
| Product 6 | 12 | 5500 |
| Product 7 | 13 | 5800 |
| Product 9998 | 100 | 100 |
| Product 9999 | 100 | 20 |
| Product 10000 | 105 | 30 |

Next, analyze the first NFT product price sequence table and sort the NFT products NP with the same price P according to the order of rarity ranking RK to generate a second NFT product price sequence table (Step S02). An example of the second NFT product price sequence table according to the first NFT product price sequence table in Table 1 is shown in Table 2 below.

TABLE 2

| NFT Product NP | Price P(ETH) | Rarity Ranking RK |
|---|---|---|
| Product 2 | 10 | 7500 |
| Product 3 | 10 | 8500 |
| Product 1 | 10 | 9500 |
| Product 4 | 11 | 6500 |
| Product 6 | 12 | 5500 |
| Product 5 | 12 | 6000 |
| Product 7 | 13 | 5800 |
| Product 9999 | 100 | 20 |
| Product 9998 | 100 | 100 |
| Product 10000 | 105 | 30 |

Then, define the first NFT product in the second NFT product price sequence table as a leading object of a first price zone, and then compare the NFT products NP with the leading object of the first price zone, a comparing criterion is to sequentially find the first NFT product NP whose price P is higher than the price P of the leading object in the first price zone and whose rarity ranking RK is higher than the rarity ranking RK of the leading object of the first price zone, and define the NFT product NP which meets the comparing criterion as a leading object of a second price zone, and define the NFT product NP prior to the leading object of the second price zone as a last object of the first price zone, the NFT products NP in the first price zone includes the leading object of the first price zone, the last object of the first price zone and all NFT products NP sorted between the leading object of the first price zone and the last object of the first price zone, and the leading object of the second price zone replaces the leading object of the first price zone and becomes a comparing target of the comparing criterion of a new price zone (Step S03). Take the content of the second NFT product price sequence table shown in Table 2 as an example, define the first NFT product NP (i.e. product 2) in the second NFT product price sequence table as the leading object of the first price zone, and then compare product 3, product 1, and product 4 with product 2 in sequence. The comparison criterion is to find the first NFT product NP whose price P is higher than the price P of product 2 and whose rarity ranking RK is higher than the rarity ranking RK of product 2, and product 4 is the first NFT product NP whose price P is higher than the price P of product 2 and whose rarity ranking RK is higher than the rarity ranking RK of product 2, then define product 4 as the leading object in the second price zone, and define the NFT product NP before product 4 (i.e. product 1) as the last object of the first price zone. Multiple NFT products NP in the first price zone include product 2, product 3 and product 1. And product 4 replaces product 1 and becomes the comparing target of the comparing criterion of the new price zone.

Repeat step S03 to sequentially find out the leading object and the last object of each price zone according to the second NFT product price sequence table and the comparing criterion (Step S04). Take the content of the second NFT product price sequence table shown in Table 2 as an example, after step S04 is executed, product 2, product 3 and product 1 are the NFT products NP of the first price zone. Product 4 is the NFT product NP of the second price zone. Product 6, product 5 and product 7 are the NFT products NP of the third price zone. Product 9999, product 9998 and product 10000 are the NFT products NP of the last price zone. It should be noted that although the price P of product 7 is higher than the price P of product 6, its rarity ranking RK is not ahead of the rarity ranking RK of product 6, so product 7 still belongs to the third price zone. Similarly, although the price P of product 10000 is higher than the price P of product 9999, because the rarity ranking RK of product 10000 is not ahead of the rarity ranking RK of product 9999, product 10000 and product 9999 still belong to the same price zone. In other words, in the embodiment shown in FIG. 4, the prices P of NFT products NP in the same price zone may not be the same.

Finally, define multiple sections S in a website according to the number of price zones in the second NFT product price sequence table, each section S is arranged along a first direction Y, and each section S includes multiple blocks arranged along a second direction X (Step S05). And sequentially display the leading object of each price zone in the second NFT product price sequence table in the first block of each section S (Step S06).

In step S05, each section S is arranged along the first direction Y, and each section S includes multiple blocks arranged along the second direction X, but the present invention is not limited thereto. For example, each section S can also be arranged along the second direction X, and each section S can also include multiple blocks arranged along the first direction Y.

In some embodiments, the exhibiting method of NFT product NP further comprises displaying, along the second direction X, the NFT products NP which are located after the leading object in each price zone individually in the block after the block where the leading object is located.

In some embodiments, the exhibiting method of NFT product NP shown in FIG. 4 further comprises selectively hiding or displaying the blocks where the NFT products NP other than the leading object in each price zone are located.

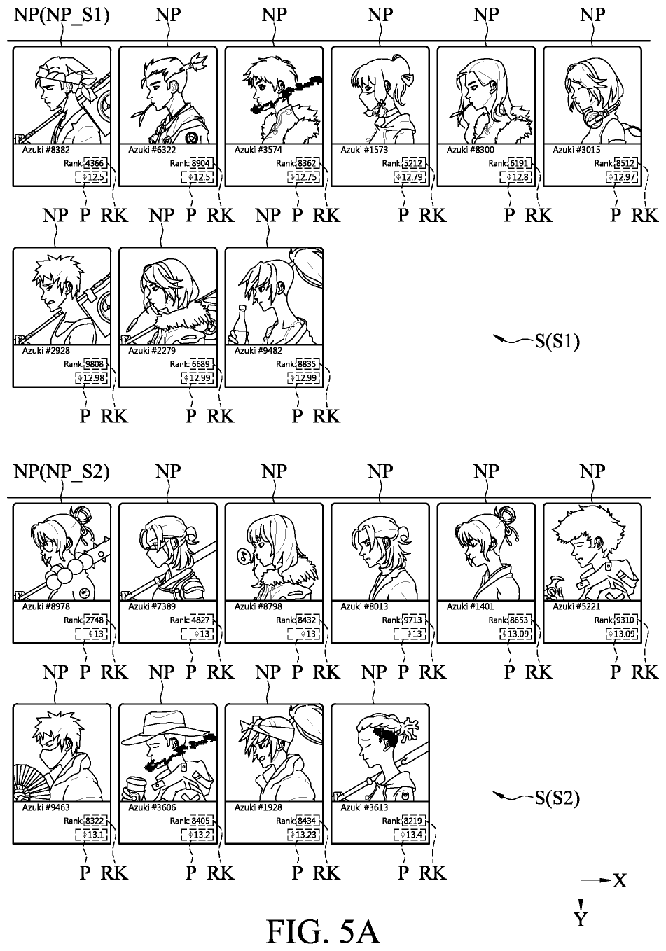

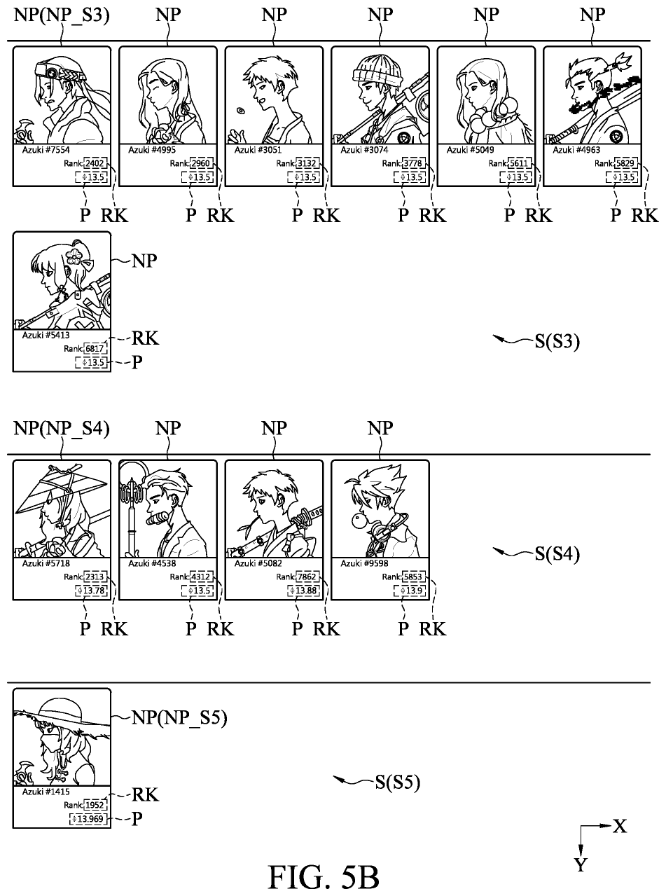

FIG. 5A and FIG. 5B are schematic diagrams of one embodiment of an exhibiting method of NFT product NP. Please refer to FIG. 4, FIG. 5A and FIG. 5B. In the embodiment shown in FIG. 5A and FIG. 5B, each section S is arranged along the first direction Y, and each section S includes multiple blocks arranged along the second direction X. For the convenience of illustration, the multiple sections S in FIG. 5A are sequentially called section S1 and section S2, the multiple sections S in FIG. 5B are sequentially called section S3, section S4, and section S5. The NFT product NP (hereinafter referred to as NFT product NP_S1) displayed in the first block of section S1 is the leading object in the price zone where it is located, with the price P of 12.5 ETH and the rarity ranking RK of 4366th. Multiple NFT products NP which are in the same price zone as the NFT product NP_S1 but ranked behind the NFT product NP_S1 are individually displayed in the block after the block where the NFT product NP_S1 is located along the second direction X. The NFT product NP (hereinafter referred to as NFT product NP_S2) displayed in the first block of section S2 is the leading object in the price zone where it is located, with the price P of 13 ETH and the rarity ranking RK of 2748th. Multiple NFT products NP which are in the same price zone as the NFT product NP_S2 but ranked behind the NFT product NP_S2 are individually displayed in the block after the block where the NFT product NP_S2 is located along the second direction X. The NFT product NP (hereinafter referred to as NFT product NP_S3) displayed in the first block of section S3 is the leading object in the price zone where it is located, with the price P of 13.5 ETH and the rarity ranking RK of 2402th. Multiple NFT products NP which are in the same price zone as the NFT product NP_S3 but ranked behind the NFT product NP_S3 are individually displayed in the block after the block where the NFT product NP_S3 is located along the second direction X. The NFT product NP (hereinafter referred to as NFT product NP_S4) displayed in the first block of section S4 is the leading object in the price zone where it is located, with the price P of 13.78 ETH and the rarity ranking RK of 2313th. Multiple NFT products NP which are in the same price zone as the NFT product NP_S4 but ranked behind the NFT product NP_S4 are individually displayed in the block after the block where the NFT product NP_S4 is located along the second direction X. The NFT product NP (hereinafter referred to as NFT product NP_S5) displayed in the first block of section S5 is the leading object in the price zone where it is located, with the price P of 13.969 ETH and the rarity ranking RK of 1952th. And as mentioned above, in each section S, the rarity ranking RK of multiple NFT products NP displayed after the first block is not prior to the NFT product NP displayed in the first block, and the price P of the NFT products NP displayed after the first block may not be the same as the price P of the NFT product NP displayed in the first block.

Since the leading object of each price zone is displayed in the first block of each section S, buyers can quickly find out the NFT product NP with the highest rarity ranking RK in different price zones according to the first block of the section S corresponding to their budget. And if the buyer is not satisfied with the NFT product NP displayed in the first block in the section S that meets his/her budget, he/she can still quickly find out the satisfactory and relatively rare NFT product NP according to the blocks after the first block of each section S sorted by rarity ranking RK. Because buyers can find the suitable target to buy more efficiently, buyers' willingness to purchase NFT products NP will also increase, which will greatly increase the activity of the NFT trading market.

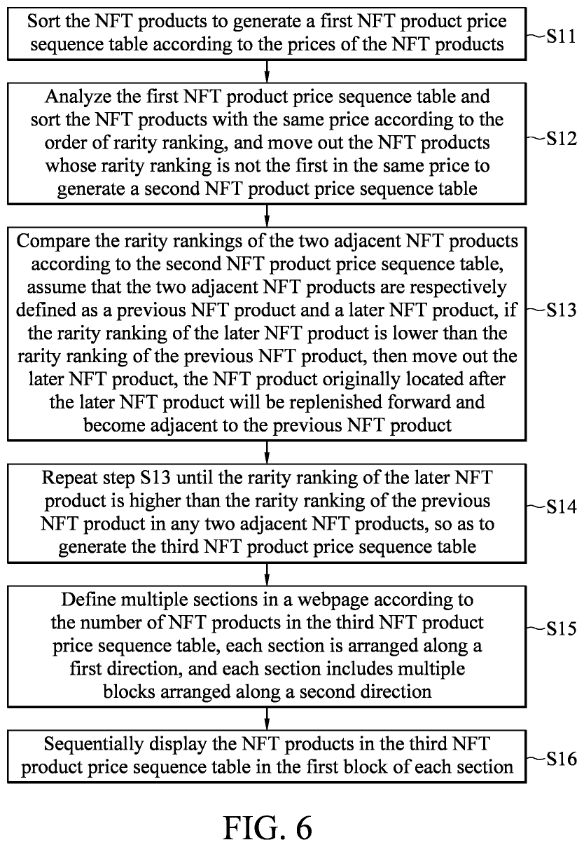

FIG. 6 is a flow chart of another embodiment of an exhibiting method of NFT product NP. Please refer to FIG. 6. The exhibiting method of NFT product applied to displaying multiple NFT products on a NFT trading website. First, sort the NFT products NP to generate a first NFT product price sequence table according to the prices P of the NFT products NP (Step S11). An example of the first NFT product price sequence table is shown in Table 1 above.

Next, analyze the first NFT product price sequence table and sort the NFT products NP with the same price P according to the order of rarity ranking RK, and move out the NFT products NP whose rarity ranking RK is not the first in the same price P to generate a second NFT product price sequence table (Step S12). In other words, in the embodiment shown in FIG. 6, for each price P, only one NFT product NP with the highest rarity ranking RK will be listed in the second NFT product price sequence table. An example of the second NFT product price sequence table according to the first NFT product price sequence table in Table 1 is shown in Table 3 below.

TABLE 3

| NFT Product NP | Price P(ETH) | Rarity Ranking RK |
|---|---|---|
| Product 2 | 10 | 7500 |
| Product 4 | 11 | 6500 |
| Product 6 | 12 | 5500 |
| Product 7 | 13 | 5800 |
| Product 9999 | 100 | 20 |
| Product 10000 | 105 | 30 |

Then, compare the rarity rankings RK of the two adjacent NFT products NP according to the second NFT product price sequence table, assume that the two adjacent NFT products NP are respectively defined as a previous NFT product NP and a later NFT product NP, if the rarity ranking RK of the later NFT product NP is lower than the rarity ranking RK of the previous NFT product NP, then move out the later NFT product NP, the NFT product NP originally located after the later NFT product NP will be replenished forward and become adjacent to the previous NFT product NP (Step S13).

Repeat step S13 until the rarity ranking RK of the later NFT product is higher than the rarity ranking RK of the previous NFT product in any two adjacent NFT products NP, so as to generate a third NFT product price sequence table (Step S14). An example of the third NFT product price sequence table according to the second NFT product price sequence table in Table 3 is shown in Table 4 below.

TABLE 4

| NFT Product NP | Price P(ETH) | Rarity Ranking RK |
|---|---|---|
| Product 2 | 10 | 7500 |
| Product 4 | 11 | 6500 |
| Product 6 | 12 | 5500 |
| Product 9999 | 100 | 20 |

Take the content of the third NFT product price sequence table shown in Table 4 as an example, after step S14 is executed. Since the rarity ranking RK of product 7 is lower than the rarity ranking RK of product 6, product 7 is moved out. Similarly, since the rarity ranking RK of product 10000 is lower than the rarity ranking RK of product 9999, product 10000 is moved out. In other words, in the embodiment shown in FIG. 6, it is not necessary that all the NFT product NP with the highest rarity ranking RK in each price P will be listed in the third NFT product price sequence table, in addition, the rarity ranking RK of each NFT product NP listed in the third NFT product price sequence table is higher than the rarity ranking RK of all NFT products NP whose price P is lower than its price P.

Finally, define multiple sections S in a website according to the number of NFT products NP in the third NFT product price sequence table, each section S is arranged along a first direction Y, and each section S includes multiple blocks arranged along a second direction X (Step S15). And sequentially display the NFT products NP in the third NFT product price sequence table in the first block of each section S (Step S16).

In step S15, each section S is arranged along the first direction Y, and each section S includes multiple blocks arranged along the second direction X, but the present invention is not limited thereto. For example, each section S can also be arranged along the second direction X, and each section S can also include multiple blocks arranged along the first direction Y.

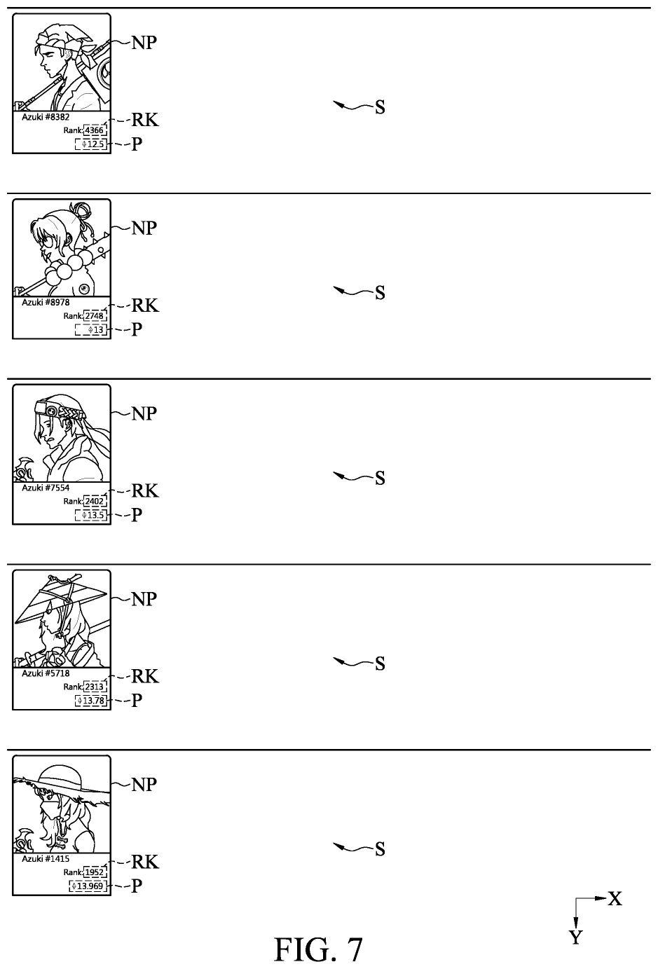

FIG. 7 is a schematic diagrams of another embodiment of an exhibiting method of NFT product NP. Please refer to FIG. 6 and FIG. 7. In the embodiment shown in FIG. 7, each section S is arranged along the first direction Y, and each section S includes multiple blocks arranged along the second direction X. And the NFT products NP in the third NFT product price sequence table are sequentially displayed in the first block of each section S and the rarity ranking RK of each NFT product NP listed in the third NFT product price sequence table is higher than the rarity ranking RK of all NFT products NP whose price P is lower than its price P.

In the embodiment shown in FIG. 6, the NFT product NP found by the buyer according to the section S corresponding to his/her budget is the NFT product NP with the highest rarity ranking RK in the same price P, and because the rarity ranking RK of each NFT product NP listed in the third NFT product price sequence table is higher than the rarity ranking RK of all NFT products NP whose price P is lower than its price P, there will not be any other NFT product NP whose price P is lower than the price P of the NFT product NP selected by the buyer but whose rarity rank RK is higher than the rarity ranking RK of the NFT product NP selected by the buyer. Compared with the traditional exhibiting method which only sorts according to the price, buyers can find the most suitable target to buy more quickly and directly.

In some embodiments, the exhibiting method of NFT product NP shown in FIG. 6 further comprises displaying, along the second direction, the NFT products NP whose rarity ranking RK is not the first in the same price P moved out in step S12 individually in the block after the first block of each section S where the NFT product NP with the same price P as the NFT products NP moved out in step S12 is located. Take the content of the first NFT product price sequence table shown in Table 1 and the second NFT product price sequence table shown in Table 3 as an example, it can be seen that the multiple NFT products NP that are moved out in step S12 due to the same price P but not the highest ranking RK are product 1, product 3, product 5, and product 9998. Product 1 and product 3 are individually displayed in the block after the first block of the section S where product 2, which has the same price P as product 1 and product 3, is located. Product 5 is individually displayed in the block after the first block of the section S where product 6, which has the same price P as product 5, is located. Product 9998 is individually displayed in the block after the first block of the section S where product 9999, which has the same price P as product 9998, is located.

In some embodiments, the NFT products NP moved out in step S12 are sequentially displayed in an order according to the rarity ranking RK. Take the content of the first NFT product price sequence table shown in Table 1 and the second NFT product price sequence table shown in Table 3 as an example, when product 1 and product 3 are individually displayed in the block after the first block of the section S where product 2, which has the same price P as product 1 and product 3, is located, due to the rarity ranking RK of product 3 is higher than the rarity ranking RK of product 1, product 3 will be displayed prior to product 1 in the block after the first block of section S where product 2 is located.

In some embodiments, the exhibiting method of NFT product NP shown in FIG. 6 further comprises displaying, along the second direction, the later NFT products NP moved out in step S13 individually in each section S where the previous NFT product NP is located, and displaying the later NFT products NP moved out in step S13 after the blocks where the NFT products NP moved out in step S12 are located. Take the content of the second NFT product price sequence table shown in Table 3 and the third NFT product price sequence table shown in Table 4 as an example, the NFT products NP which are moved out in step S13 because of the reason that its rarity ranking RK is lower than the rarity ranking RK of the previous NFT product NP include product 7 and product 10000. Product 7 is displayed individually in the section S where the previous NFT product NP (i.e. product 6) is located, and is displayed after the block where product 5, which is moved out in step S12, is located. Product 10000 is displayed individually in the section S where the previous NFT product NP (i.e. product 9999) is located, and is displayed after the block where product 9998, which is moved out in step S12, is located.

In some embodiments, the later NFT products NP moved out in step S13 are sequentially displayed after the blocks where the NFT products NP moved out in step S12 are located in an order according to the price P.

In some embodiments, the exhibiting method of NFT product NP shown in FIG. 6 further comprises selectively hiding or displaying the blocks where the later NFT products NP moved out in step S13 are located.

In some embodiments, the exhibiting method of NFT product NP shown in FIG. 6 further comprises selectively hiding or displaying the blocks where the NFT products NP moved out in step S12 are located.

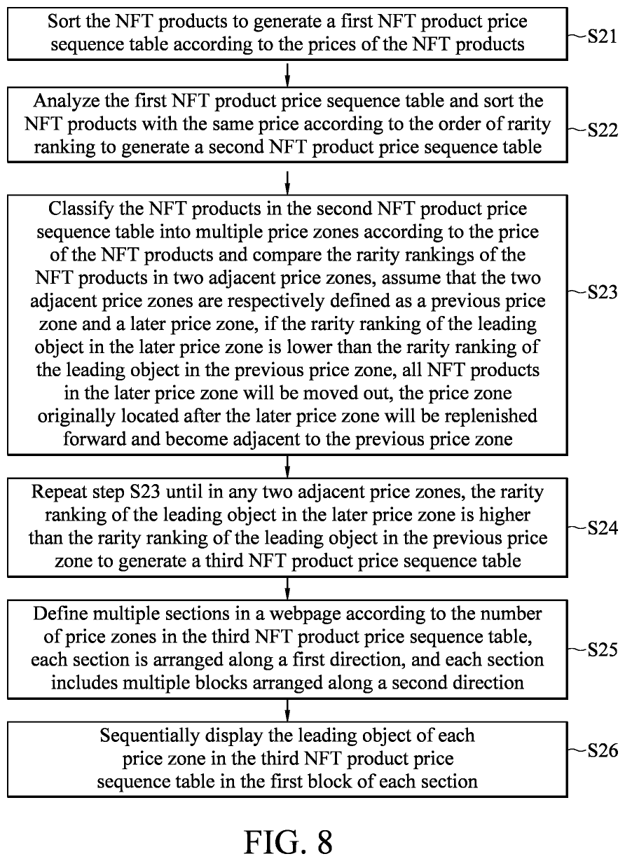

FIG. 8 is a flow chart of the other embodiment of an exhibiting method of NFT product NP. Please refer to FIG. 8. The exhibiting method of NFT product applied to displaying multiple NFT products on a NFT trading website. First, sort the NFT products NP to generate a first NFT product price sequence table according to the prices P of the NFT products NP (Step S21). An example of the first NFT product price sequence table is shown in Table 1 above.

Next, analyze the first NFT product price sequence table and sort the NFT products NP with the same price P according to the order of rarity ranking RK to generate a second NFT product price sequence table (Step S22). An example of the second NFT product price sequence table according to the first NFT product price sequence table in Table 1 is shown in Table 2 above.

Then, classify the NFT products NP in the second NFT product price sequence table into multiple price zones according to the price P of the NFT products NP and compare the rarity rankings RK of the NFT products NP in two adjacent price zones, assume that the two adjacent price zones are respectively defined as a previous price zone and a later price zone, if the rarity ranking RK of the leading object in the later price zone is lower than the rarity ranking RK of the leading object in the previous price zone, all NFT products NP in the later price zone will be moved out, the price zone originally located after the later price zone will be replenished forward and become adjacent to the previous price zone (Step S23).

Repeat step S23 until in any two adjacent price zones, the rarity ranking RK of the leading object in the later price zone is higher than the rarity ranking RK of the leading object in the previous price zone to generate a third NFT product price sequence table (Step S24). An example of the third NFT product price sequence table is shown in Table 5 below.

TABLE 5

| NFT Product NP | Price P(ETH) | Rarity Ranking RK |
|---|---|---|
| Product 2 | 10 | 7500 |
| Product 3 | 10 | 8500 |
| Product 1 | 10 | 9500 |
| Product 4 | 11 | 6500 |
| Product 6 | 12 | 5500 |
| Product 5 | 12 | 6000 |
| Product 9999 | 100 | 20 |
| Product 9998 | 100 | 100 |

Take the content of the third NFT product price sequence table shown in Table 5 as an example, product 2, product 3 and product 1 are NFT products NP in the first price zone. Product 4 is the NFT product NP in the second price zone. Product 6 and product 5 are NFT products NP in the third price zone. Product 9999 and product 9998 are the NFT products NP in the last price zone. It should be noted that since the rarity ranking RK of product 7 is lower than the rarity ranking RK of product 6, all NFT products NP in the price zone where product 7 is located are moved out. Similarly, since the rarity ranking RK of product 10000 is lower than the rarity ranking RK of product 9999, all NFT products NP in the price zone where product 10000 is located are moved out.

Finally, define multiple sections S in a website according to the number of price zones in the third NFT product price sequence table, each section S is arranged along a first direction Y, and each section S includes multiple blocks arranged along a second direction X (Step S25). And sequentially display the leading object of each price zone in the third NFT product price sequence table in the first block of each section S (Step S26).

In step S25, each section S is arranged along the first direction Y, and each section S includes multiple blocks arranged along the second direction X, but the present invention is not limited thereto. For example, each section S can also be arranged along the second direction X, and each section S can also include multiple blocks arranged along the first direction Y.

In some embodiments, the exhibiting method of NFT product NP further comprises displaying, along the second direction X, the NFT products NP which are located after the leading object in the same price zone individually in the block after the block where the leading object is located.

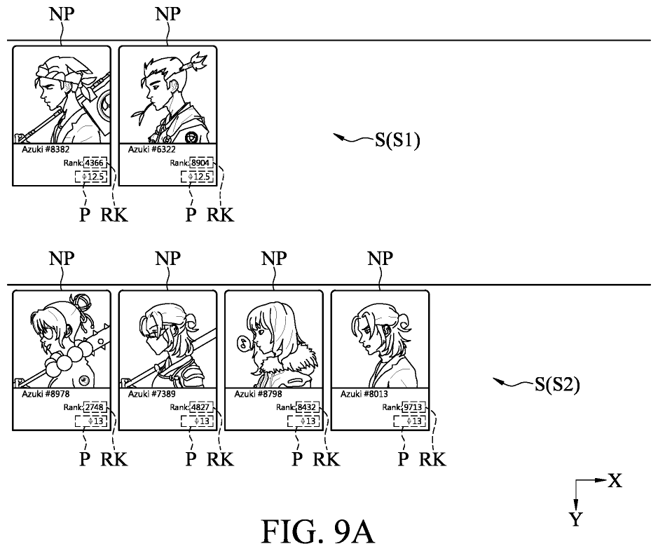

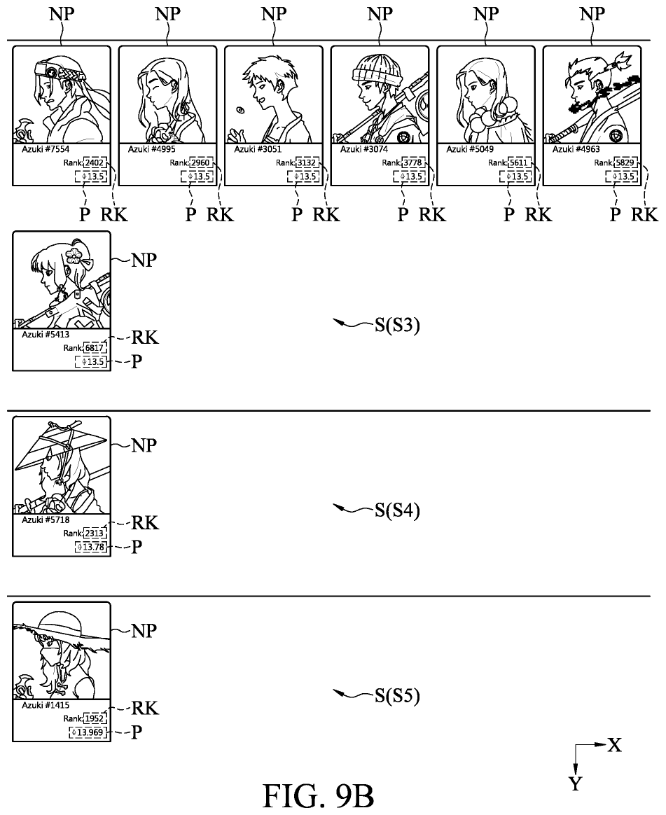

FIG. 9A and FIG. 9B are schematic diagrams of the other embodiment of an exhibiting method of NFT product NP. Please refer to FIG. 8, FIG. 9A, and FIG. 9B. In the embodiment shown in FIG. 9A and FIG. 9B, each section S is arranged along the first direction Y, and each section S includes multiple blocks arranged along the second direction X. For the convenience of illustration, the multiple sections S in FIG. 9A are sequentially called section S1 and section S2, the multiple sections S in FIG. 9B are sequentially called section S3, section S4, and section S5. The multiple NFT products NP displayed in section S1 are the NFT products NP with the price P of 12.5 ETH. The multiple NFT products NP displayed in section S2 are the NFT products NP with the price P of 13 ETH. The multiple NFT products NP displayed in section S3 are the NFT products NP with the price P of 13.5 ETH. The NFT product NP displayed in section S4 is the NFT product NP with the price P of 13.78 ETH. The NFT product NP displayed in section S5 is the NFT product NP with the price P of 13.969 ETH. Compared with the embodiment shown in FIG. 5A and FIG. 5B, in the embodiment shown in FIG. 9A and FIG. 9B, the prices P of all NFT products NP displayed in the same section S are the same, and there is no NFT product NP with different price P will be displayed in the same section S.

In some embodiments, the NFT products NP located after the leading object in each price zone are sequentially displayed after the block where the leading object with the same price P is located in an order according to the rarity ranking RK.

In some embodiments, the exhibiting method of NFT product NP shown in FIG. 8 further comprises displaying, along the second direction, the NFT products NP in the later price zone moved out in step S23 individually in each section S where the NFT products NP in the previous price zone are located. Take the content of the second NFT product price sequence table shown in Table 2 and the third NFT product price sequence table shown in Table 5 as an example, the multiple NFT products NP which are moved out in step S23 because of the reason that the rarity ranking RK of the leading object in its price zone is lower the rarity ranking RK of the leading object in its previous price zone include product 7 and product 10000. Product 7 is displayed individually in the section S where the NFT products NP in the previous price zone (i.e. the price zone of product 6 and product 5) are located. Product 10000 is displayed individually in the section S where the NFT products NP in the previous price zone (i.e. the price zone of product 9999 and product 9998) are located.

In some embodiments, the exhibiting method of NFT product NP shown in FIG. 8 further comprises displaying, along the second direction, the NFT products NP in the later price zone moved out in step S23 in each section S where the multiple NFT products NP in the previous price zone, which is adjacent to the later price zone, are located individually in an order according to the order of the second NFT product price sequence table.

In some embodiments, the exhibiting method of NFT product NP shown in FIG. 8 further comprises selectively hiding or displaying the blocks where the NFT products NP in the later price zone moved out in step S23 are located.

In some embodiments, the exhibiting method of NFT product NP shown in FIG. 8 further comprises selectively hiding or displaying the blocks where the NFT products NP located after the leading object in each price zone are located.

In some embodiments, the first direction Y is the vertical direction of the website, and the second direction X is the horizontal direction of the website.

In some embodiments, the device which executes the exhibiting method of NFT product NP may be but not limited to a smartphone, a tablet, a personal computer or a notebook.

In some embodiments, the exhibiting method of NFT product NP can be realized by software, firmware or hardware.

In some embodiments, the hardware which can realize the exhibiting method of NFT product NP may be but not limited to central processing unit (CPU), microprocessor, digital signal processor (DSP), complex programmable logic device (CPLD), field programmable gate array (FPGA), application specific integrated circuits (ASIC) or microcontroller unit.

As above, in some embodiments, buyers can quickly find out the NFT product NP with the highest rarity ranking RK according to the section S corresponding to their budget, which saves a lot of time spent viewing the NFT product NP data. And because buyers can find out suitable targets to buy efficiently, buyers' willingness to purchase NFT product NP will also increase, which will greatly increase the activity of the NFT trading market.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An exhibiting method of NFT product, applied to displaying multiple NFT products on a NFT trading website, each NFT product has a price and a rarity ranking, the exhibiting method of NFT product comprising:
a. sorting the NFT products to generate a first NFT product price sequence table according to the prices of the NFT products;
b. analyzing the first NFT product price sequence table and sorting the NFT products with the same price according to the order of rarity ranking, and moving out the NFT products whose rarity ranking is not the first in the same price to generate a second NFT product price sequence table;
c. comparing the rarity rankings of the two adjacent NFT products according to the second NFT product price sequence table, the two adjacent NFT products are respectively defined as a previous NFT product and a later NFT product, if the rarity ranking of the later NFT product is lower than the rarity ranking of the previous NFT product, then moving out the later NFT product, the NFT product originally located after the later NFT product will be replenished forward and become adjacent to the previous NFT product;
d. repeating step c until the rarity ranking of the later NFT product is higher than the rarity ranking of the previous NFT product in any two adjacent NFT products, so as to generate a third NFT product price sequence table;
e. defining multiple sections in a website according to the number of NFT products in the third NFT product price sequence table, each section includes multiple blocks; and
f. sequentially displaying the NFT products in the third NFT product price sequence table in the first block of each section.

2. The exhibiting method of NFT product according to claim 1, wherein each section is arranged along a first direction, and each section includes multiple blocks arranged along a second direction, the exhibiting method further comprising:
displaying, along the second direction, the NFT products moved out in step b individually in the block after the first block of each section where the NFT product with the same price as the NFT products moved out in step b is located.

3. The exhibiting method of NFT product according to claim 2, wherein the NFT products moved out in step b are sequentially displayed in an order according to the rarity ranking.

4. The exhibiting method of NFT product according to claim 3, further comprising:
displaying, along the second direction, the later NFT products moved out in step c individually in each section where the previous NFT product is located, and displaying the later NFT products moved out in step c after the blocks where the NFT products moved out in step b are located.

5. The exhibiting method of NFT product according to claim 4, further comprising:
selectively hiding or displaying the blocks where the later NFT products moved out in step c are located.

6. The exhibiting method of NFT product according to claim 5, wherein the first direction is the vertical direction of the website, and the second direction is the horizontal direction of the website.

7. The exhibiting method of NFT product according to claim 3, further comprising:
selectively hiding or displaying the blocks where the NFT products moved out in step b are located.

8. The exhibiting method of NFT product according to claim 1, wherein each section is arranged along a first direction, and each section includes multiple blocks arranged along a second direction, the exhibiting method further comprising:
displaying, along the second direction, the later NFT products moved out in step c individually in the block after the first block of each section where the previous NFT product is located.

9. The exhibiting method of NFT product according to claim 8, further comprising:
selectively hiding or displaying the blocks where the later NFT products moved out in step c are located.

10. An exhibiting method of NFT product, applied to displaying multiple NFT products on a NFT trading website, each NFT product has a price and a rarity ranking, the exhibiting method of NFT product comprising:
a. sorting the NFT products to generate a first NFT product price sequence table according to the prices of the NFT products;
b. analyzing the first NFT product price sequence table and sorting the NFT products with the same price according to the order of rarity ranking to generate a second NFT product price sequence table;
c. defining the first NFT product in the second NFT product price sequence table as a leading object of a first price zone, and then comparing the NFT products with the leading object of the first price zone, a comparing criterion is to sequentially find the first NFT product whose price is higher than the price of the leading object in the first price zone and whose rarity ranking is higher than the rarity ranking RK of the leading object of the first price zone, and defining the NFT product which meets the comparing criterion as a leading object of a second price zone, and defining the NFT product prior to the leading object of the second price zone as a last object of the first price zone, the NFT products in the first price zone includes the leading object of the first price zone, the last object of the first price zone and all NFT products sorted between the leading object of the first price zone and the last object of the first price zone, and the leading object of the second price zone replaces the leading object of the first price zone and becomes a comparing target of the comparing criterion of a new price zone;
d. repeating step c, sequentially finding out the leading object and the last object of each price zone according to the second NFT product price sequence table and the comparing criterion;
e. defining multiple sections in a website according to the number of price zones in the second NFT product price sequence table, each section includes multiple blocks; and
f. sequentially displaying the leading object of each price zone in the second NFT product price sequence table in the first block of each section.

11. The exhibiting method of NFT product according to claim 10, wherein each section is arranged along a first direction, and each section includes multiple blocks arranged along a second direction, the exhibiting method further comprising:
displaying, along the second direction, the NFT products which are located after the leading object in the same price zone individually in the block after the block where the leading object is located.

12. The exhibiting method of NFT product according to claim 11, further comprising:
selectively hiding or displaying the blocks where the NFT products other than the leading object in each price zone are located.

13. An exhibiting method of NFT product, applied to displaying multiple NFT products on a NFT trading website, each NFT product has a price and a rarity ranking, the exhibiting method of NFT product comprising:
a. sorting the NFT products to generate a first NFT product price sequence table according to the prices of the NFT products;
b. analyzing the first NFT product price sequence table and sorting the NFT products with the same price according to the order of rarity ranking to generate a second NFT product price sequence table;
c. Classifying the NFT products in the second NFT product price sequence table into multiple price zones according to the price of the NFT products and comparing the rarity rankings of the NFT products in two adjacent price zones, the two adjacent price zones are respectively defined as a previous price zone and a later price zone, if the rarity ranking of the leading object in the later price zone is lower than the rarity ranking of the leading object in the previous price zone, all NFT products in the later price zone will be moved out, the price zone originally located after the later price zone will be replenished forward and become adjacent to the previous price zone;
d. repeating step c until in any two adjacent price zones, the rarity ranking of the leading object in the later price zone is higher than the rarity ranking of the leading object in the previous price zone to generate a third NFT product price sequence table;
e. defining multiple sections in a website according to the number of price zones in the third NFT product price sequence table, and each section includes multiple blocks; and
f. sequentially displaying the leading object of each price zone in the third NFT product price sequence table in the first block of each section.

14. The exhibiting method of NFT product according to claim 13, wherein each section is arranged along a first direction, and each section includes multiple blocks arranged along a second direction, the exhibiting method further comprising:
displaying, along the second direction, the NFT products located after the leading object with the same price individually in the block after the block where the leading object is located.

15. The exhibiting method of NFT product according to claim 14, wherein the NFT products located after the leading object with the same price are sequentially displayed in an order according to the rarity ranking.

16. The exhibiting method of NFT product according to claim 15, further comprising:
displaying, along the second direction, the NFT products in the later price zone moved out in step c individually in each section where the NFT products in the previous price zone are located.

17. The exhibiting method of NFT product according to claim 16, further comprising:
selectively hiding or displaying the blocks where the later NFT products moved out in step c are located.

18. The exhibiting method of NFT product according to claim 17, further comprising:
selectively hiding or displaying the blocks where the NFT products located after the leading object are located.

19. The exhibiting method of NFT product according to claim 13, wherein each section is arranged along a first direction, and each section includes multiple blocks arranged along a second direction, the exhibiting method further comprising:
displaying, along the second direction, the NFT products in the later price zone moved out in step c individually in each section where the NFT products in the previous price zone are located.

20. The exhibiting method of NFT product according to claim 19, further comprising:
selectively hiding or displaying the blocks where the later NFT products moved out in step c are located.
